(19) United States
(12) Patent Application Publication
(10) Pub. No.: US 2023/0003448 A1
(43) Pub. Date: Jan. 5, 2023

(54) TRANSPORT SYSTEM IN THE BEVERAGE INDUSTRY AND COMPUTER-CONTROLLED OR ELECTRONIC METHOD FOR OPERATING THE TRANSPORT SYSTEM

(71) Applicant: Krones AG, Neutraubling (DE)

(72) Inventor: Anna Zweigardt, Harrislee (DE)

(21) Appl. No.: 17/783,606

(22) PCT Filed: Sep. 18, 2020
(86) PCT No.: PCT/EP2020/076085

§ 371 Date: Jun. 8, 2022

(30) Foreign Application Priority Data
Dec. 16, 2019 (DE) 10 2019 134 501.4

(51) Int. Cl. F26B 15/18; B65C 9/00; F26B 21/00

(52) U.S. Cl. CPC F26B 15/18; B65C 9/0015; F26B 21/004; B65C 2009/0059

(57) ABSTRACT

The invention relates to a transport system (1, 10, 14) in the beverage industry with a transport device (TR) which is designed to transport containers (3) through the transport system in a transport direction, having a rinsing region (4, 18) which is designed to form a liquid curtain (5, 19) through which containers that can be transported by the transport device (2) can pass. The invention furthermore relates to a computer-controlled or electronic method for operating the transport system.

### RELATED APPLICATIONS

This application claims the benefit of International Application No. PCT/EP2020/076085, filed Sep. 18, 2020, which claims priority to German Application No. DE102019134501.4, filed Dec. 16, 2019. The entire contents of both applications are hereby incorporated by reference.

### TECHNICAL FIELD

The present disclosure relates to a transport system for transporting containers (e.g., beverage containers) and a computer-controlled or electronic method for operating the transport system.

### BACKGROUND

Conventional air nozzle drying systems are known wherein air is directed at high speed to the surfaces of containers to be dried, such as bottles, cans, and/or packs. Liquid adhering to the surfaces of the containers can be blown off (e.g., at least partially blown off). In particular, it might be difficult, or impossible, to blow off small water drops using conventional systems.

In order to ensure, for example, a flawless (e.g., nearly flawless) labeling of the containers, it is necessary to efficiently dry the surfaces of the containers when they leave a container treatment machine, such as a pasteurizer, a cooler, or a heater.

### SUMMARY

Accordingly, the present disclosure provides a transport system for transporting containers and a computer-controlled and/or electronic method for operating the transport system (e.g., for the beverage industry). The computer-controlled and/or electronic method can show a drying result after a surface treatment of containers with a liquid. The drying result may provide a further trouble-free treatment of the containers, such as labeling of the containers.

The present disclosure relates to a transport system with a transport device which is designed to transport containers through the transport system in a transport direction, having a rinsing region which is designed to form a liquid curtain through which containers transported by the transport device can pass.

The containers can comprise bottles, cans or packs.

The liquid curtain can be a continuous, freely falling liquid film. The liquid curtain can extend across a width (the width can extend, for example, perpendicularly to the transport direction) which corresponds to a total width of the transport direction, for example, or the width of the liquid curtain can also be smaller than the total width of the transport device, wherein a minimum width of the liquid curtain can be, for example, 2% to 5% larger than a maximum width of the containers that pass the liquid curtain. The width of the liquid curtain can be variable, for example, by switching on or off existing liquid nozzles.

A height (the height can extend, for example, in parallel to a longitudinal axis of the containers) of the liquid curtain can be provided such that containers of a given height can pass the liquid curtain and thereby their surfaces can be completely wetted with a liquid. The height of the liquid curtain can be variable, for example by providing height-adjustable liquid nozzles.

By passing through the liquid curtain, the containers can be wetted with liquid. The presence of small liquid drops (e.g., having a diameter ≤1 mm), which do not run off downwards so easily by the action of the force of gravity and/or are difficult to blow off from the surfaces of the containers than larger liquid drops, can be avoided.

By rinsing the containers with the liquid curtain, liquid drops form in a size on the surfaces of the containers that run off downwards from the surfaces of the containers by the action of the force of gravity. Since the majority of the liquid can thus run off down from the containers under the action of gravitational force, after the containers have passed the liquid curtain, no more small liquid drops (e.g., having a diameter 1 mm) which are difficult to blow off, are present on the surfaces of the containers. Containers treated in this manner can be dryer by up to 60% after they have been rinsed with the liquid curtain, compared to containers whose surfaces have only been sprayed with liquid. The liquid curtain can thus serve to dry the containers.

The rinsing region can furthermore be configured to form the liquid curtain across a total width of the transport device. In this way, a plurality of containers transported on the transport device one next to the other can pass through the liquid curtain.

The rinsing region can furthermore be designed to form the liquid curtain with a thickness within a range of 0.5 mm to 15 mm. Thus, containers with differently dimensioned diameters and/or external forms can be wetted with liquid of the liquid curtain.

In the rinsing region, a spraying device can be provided for forming the liquid curtain. The spraying device can comprise, for example, 2-5 liquid nozzles per meter of the liquid curtain. The liquid nozzles can comprise fan nozzles. The spraying device can permit a uniform formation of the liquid curtain. For example, the spraying device can be designed to be vertically movable, so that a height of the liquid curtain can be variable, for example to provide the height of the liquid curtain such that containers of a given height can pass the liquid curtain and their surfaces can be completely wetted with liquid in the process.

The rinsing region can be furthermore configured to provide a flow rate of the liquid along the liquid curtain within a range of 60 liters per hour per meter of the liquid curtain to 600 liters per hour per meter of the liquid curtain. The flow rate can be controlled and/or determined depending on the height and/or thickness of the liquid curtain.

The liquid can be or comprise water. The liquid can comprise, for example, surface-active substances. By the surface-active substances, the surface tension of liquid adhering to the containers can be reduced, so that the liquid can more easily run off from the containers. The liquid can be the liquid that is used for forming the liquid curtain, and/or the liquid that can be used in a container treatment region of a container treatment machine described hereinafter.

The transport system can furthermore comprise a basin which is arranged underneath the rinsing region and is designed to receive liquid from the rinsing region. The liquid can thus be collected to be reused.

The rinsing region can furthermore be designed to use liquid from the basin to form the liquid curtain. In this manner, no additional liquid demand is required to form the liquid curtain.

The transport system can furthermore comprise a container treatment machine comprising a container treatment region which is designed to treat containers that can be transported through the transport device, the rinsing region directly following the container treatment region in the transport direction. In the container treatment region, liquid can be sprayed onto the containers, for example.

The rinsing region can be comprised by the container treatment machine. This means, the container treatment machine can comprise, for example, a pasteurizer, a cooler or heater, and/or the rinsing region.

The rinsing region can be provided separately from the container treatment machine. The container treatment machine can be a pasteurizer, cooler or heater followed by the rinsing region.

The container treatment region can be designed to spray liquid such that the liquid can be sprayed onto the containers or that the containers can be sprinkled with the liquid. By spraying the liquid, the containers can be, for example, pasteurized in a pasteurizer, the containers can be cooled in a cooler, and the containers can be heated in a heater in this manner. After having passed the container treatment region, the containers can be transported to the rinsing region with the transport device where they can pass the liquid curtain which can be generated by a spraying device, for example. As the containers can be wetted by liquid of the liquid curtain, liquid drops which still adhere to the containers after they have left the container treatment region can be absorbed by the liquid of the liquid curtain. In this way, no small drops (e.g., substantially no small drops, few small drops, etc.) can adhere to the containers after they have passed the liquid curtain, so that the containers can be dryer than after they have passed the container treatment region. For example, a blow-drying of the containers in a drying region can be effected more easily in this way since no small drops are present on the container's surface.

The transport system can furthermore comprise a basin which is arranged underneath the rinsing region and the container treatment region and is designed to receive liquid from the rinsing region and the container treatment region. The liquid can thus be collected to be reused.

The rinsing region can furthermore be designed to use liquid from the basin to form the liquid curtain. In this manner, no additional liquid demand is required to form the liquid curtain.

The transport system can furthermore comprise a drying region which can follow the rinsing region in the transport direction and can be designed to generate an airflow to be able to additionally blow surfaces of the containers dry.

The rinsing region and the drying region can be comprised by the container treatment machine. That means, the container treatment machine can comprise, for example, a pasteurizer, a cooler or heater, and the rinsing region, and/or the rinsing region and the drying region.

The rinsing region and the drying region can be provided separately from the container treatment machine. The container treatment machine can be a pasteurizer, cooler or heater followed by the rinsing region or the rinsing region and the drying region.

The container treatment machine can be embodied as a pasteurizer, a cooler and/or a heater.

In particular, downstream of the container treatment machine, a packaging device can be arranged to connect at least two containers to a pack.

The packaging device can comprise, for example, nozzles for applying glue onto the containers' external surfaces so that these are directly connected to each other.

As an alternative or in addition, the packaging device can comprise a cardboard and/or foil supply by means of which the cardboard and/or the foil are supplied to at least partially envelope the containers.

Directly upstream of this packaging device, a drying device can be arranged which dries the containers.

The present disclosure further relates to a computer-controlled and/or an electronic method (e.g., software) for operating the transport system as described above or below.

### BRIEF DESCRIPTION OF THE DRAWINGS

The included figures represent, by way of example, aspects of the invention for a better understanding and for illustrating the invention. In the drawings:

FIG. 1 shows a longitudinal section through a first embodiment of a transport system,

FIG. 2 shows a longitudinal section through a second embodiment of a transport system,

FIG. 3 shows a longitudinal section through a third embodiment of a transport system, and

FIG. 4 shows a cross-section through the rinsing region of the third embodiment of the transport system.

### DETAILED DESCRIPTION

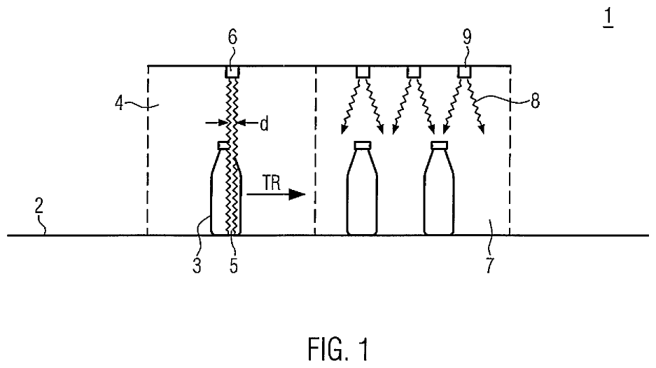

FIG. 1 shows a longitudinal section through a first embodiment of a transport system 1 comprising a transport device 2 by which containers 3 are transported in a transport direction TR. In the representation, the containers 3 are transported upright on the transport device 2. The transport device 2 may be, for example, a conveyor belt or the like.

Initially, the containers 3 reach a rinsing region 4 and are transported through it. Thereby, the containers 3 pass a liquid curtain 5 which is generated by a spraying device 6. The containers 3 are wetted by liquid of the liquid curtain 5 in the process. For example, the surface of the containers 3 is covered by a liquid film. The spraying device 6 can be designed in the form of a spraying beam which has, for example, a continuous outlet cross-section across the total transport belt's width, or in the form of a spraying tube with a plurality of fan nozzles arranged across the transport belt's width. The spraying tube contains a plurality of fan nozzles arranged across the transport belt's width. For example, the spraying tube may include 2-5 nozzles per meter of the spraying curtain 5. The liquid curtain 5 can be oriented perpendicular or substantially perpendicular to the transport direction TR and have a thickness d. For example, the liquid falls downwards in the liquid curtain 5 only by gravitational force. After the containers have passed the liquid curtain 5, the majority of the liquid can flow down from the containers 3 under the action of gravitational force, so that no small liquid drops (diameter smaller than 1 mm) which are difficult to blow off are present anymore.

Optionally, the containers 3 can be transported from the rinsing region 4 to and/or through a drying region 7 in which the containers 3 are blown dry additionally, i. e. their surfaces, by an airflow 8 which is generated by air discharged from blow nozzles 9, i. e. the liquid still adhering to the surfaces of the containers 3 is displaced from the surface, for example blown away, or dries). Instead of the blow nozzles, a blow beam can be employed as an alternative.

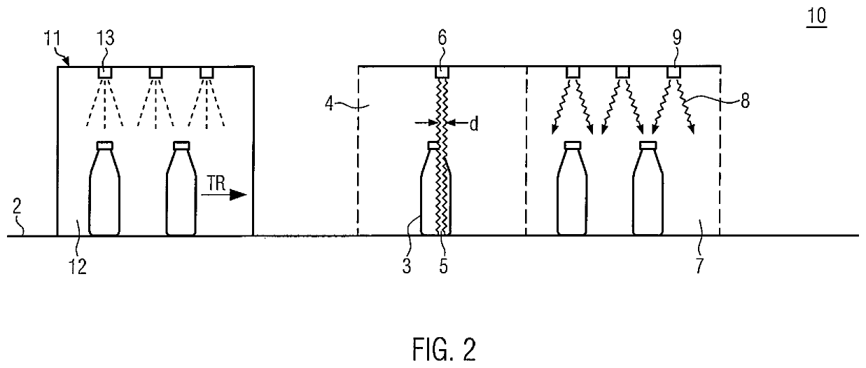

FIG. 2 shows a longitudinal section through a second embodiment of a transport system 10. Apart from the elements of the first embodiment of the transport system 1 already described in FIG. 1, the second embodiment of the transport system 10 moreover comprises a container treatment machine 11 with a container treatment region 12 which is arranged upstream of the rinsing region 4 and upstream of the optional drying region 7 in the transport direction TR. Between the container treatment machine 11 and the rinsing region 4, no further type of container treatment may be provided, so that the rinsing region 4 can be considered as directly following the container treatment region 12 in the transport direction TR in some embodiments.

The containers 3 are transported through the container treatment machine 11 by the transport device 2, and in the container treatment region 12, liquid is sprayed onto the containers 3 by means of spray nozzles 13, or the containers 3 are sprinkled by means of the liquid discharged from the spray nozzles 13. Subsequently, the containers 3 are further transported into the rinsing region 4 with the transport device 2, where the containers 3 pass the liquid curtain 5 as already described with respect to FIG. 1. As the containers 3 can be wetted by liquid of the liquid curtain 5, liquid drops which still adhere to the containers 3 after the containers 3 have left the container treatment region 12 can also be absorbed by the liquid.

The optional subsequent blow-drying of the containers 3 in the drying region 7 can thus be accomplished more easily since no small drops are present.

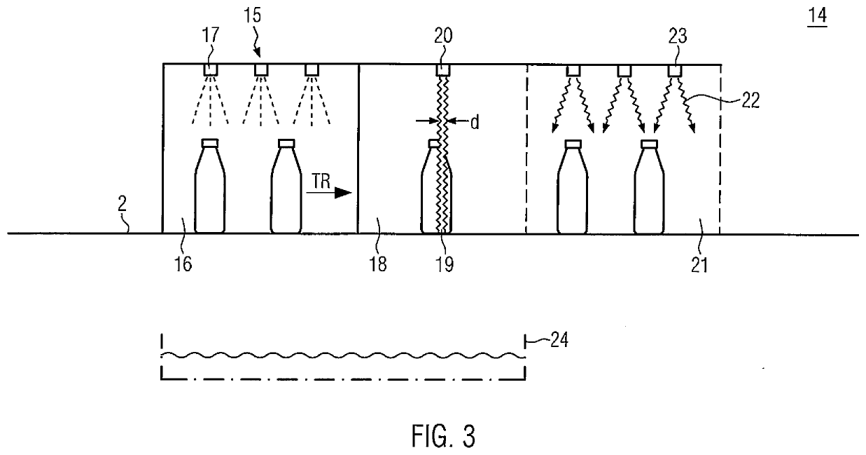

FIG. 3 shows a longitudinal section through a third embodiment of a transport system 14 comprising a container treatment machine 15, wherein the container treatment region 16, the rinsing region 18, and the optional drying region 21 are comprised by the container treatment machine 15. The containers 3 are transported by the transport device 2 in the transport direction TR, so that the transport device 2 transports the containers 3 in and through the container treatment region 16, wherein by means of the spray nozzles 17, liquid is sprayed onto the containers 3, or the containers 3 are sprinkled by the liquid discharged from the spray nozzles 17. Subsequently, the containers 3 are further transported into the rinsing region 18 with the transport device 2 where they pass the liquid curtain 19 which is generated by the spraying device 20. As the containers 3 can be wetted by liquid of the liquid curtain 19, liquid drops which still adhere to the containers 3 after the containers 3 have left the container treatment region 16 can also be absorbed by the liquid. In this manner, no small drops adhere to the containers 3 anymore, and the optional blow-drying of the containers 3 in the drying region 21 can be accomplished more easily since no small drops are present. The containers 3 (e.g., the surfaces of the containers 3) are blown dry by an airflow 22 which is generated by means of air discharged by means of blow beams 23, (e.g., the liquid still adhering to the surfaces of the containers 3 is displaced from the surface, for example blown away, or dries).

Underneath the container treatment region 16 and the rinsing region 18, an optional basin 24 is represented in a dot-dash line which can receive liquid from the container treatment region 16 and from the rinsing region 18.

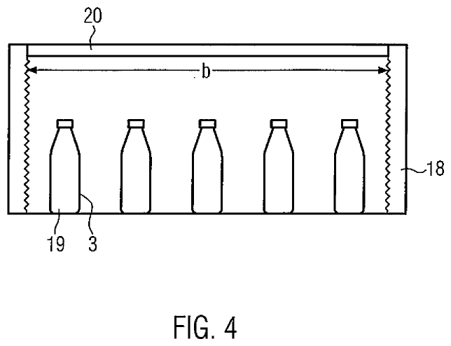

FIG. 4 shows a cross-section through the rinsing region 18 of the third embodiment of the transport system 14. The spraying device 20 is arranged—as already described in the embodiment with respect to FIG. 1 by way of example—above the transport device 2, and the liquid curtain 19 is formed across the total width b of the transport device 2. In this way, a plurality of containers 3 transported on the transport device 2 one next to the other can pass the liquid curtain 19.

1. A transport system comprising:
a transport device configured to transport one or more containers through the transport system in a transport direction; and
a rinsing region configured to form a liquid curtain for drying the one or more containers, wherein the transport device is configured to transport the one or more containers through the liquid curtain.

2. The transport system according to claim 1, wherein the rinsing region further configured to form the liquid curtain across a total width of the transport device.

3. The transport system according to claim 1, wherein the rinsing region is further configured to form the liquid curtain with a width of 0.5 mm to 15 mm.

4. The transport system according to claim 1, wherein the rinsing region, comprises a spraying device configured to form the liquid curtain, wherein the spraying device comprises, a plurality of liquid nozzles per meter width of the liquid curtain.

5. The transport system according to claim 1, to wherein the rinsing region is further configured to provide a flow rate of the liquid of the liquid curtain within a range of 60 liters per hour per meter of the liquid curtain to 600 liters per hour per meter of the liquid curtain.

6. The transport system according to claim 1, wherein the liquid of the liquid curtain comprises at least one of water or surface-active substances.

7. A transport system according to claim 1, further comprising a basin arranged underneath the rinsing region and is configured to receive liquid from the rinsing region.

8. The transport system according to claim 7, wherein the rinsing region is further configured to use liquid received by the basin to form the liquid curtain.

9. The transport system according to claim 1, further comprising:
a container treatment machine comprising:
a container treatment region configured to treat the one or more containers transported by the transport device, wherein the rinsing region follows the container treatment region in the transport direction.

10. The transport system according to claim 9, wherein the rinsing region is comprised by the container treatment machine.

11. The transport system according to claim 9, wherein the rinsing region is separate from the container treatment machine.

12. The transport system according to claim 9, wherein the container treatment region is configured to spray or sprinkle liquid onto the one or more containers.

13. The transport system according to claim 9, further comprising:
a basin arranged underneath the rinsing region and the container treatment region, wherein the basin is configured to receive liquid from the rinsing region and the container treatment region.

14. The transport system according to claim 13, wherein the rinsing region is further configured to use liquid received by the basin to form the liquid curtain.

15. The transport system according to claim 1, further comprising:
a drying region following the rinsing region in the transport direction, wherein the drying region is configured to generate an airflow to blow one or more surfaces of the one or more containers dry.

16. The transport system according to claim 15, wherein the rinsing region and the drying region are comprised by a container treatment machine.

17. The transport system according to claim 15, wherein the rinsing region and the drying region are separate from a container treatment machine.

18. The transport system according to claim 9, wherein the container treatment machine is a pasteurizer, a cooler or a heater.

19. (canceled)

20. A method for transporting one or more containers through a transport system, the method comprising:
transporting, via a transporting device, one or more containers through a liquid curtain of a rinsing region of the transport system, wherein the transport device is configured to transport the one or more containers through the transport system in a transport direction; and
transporting, via the transporting device, the one or more containers through a drying region of the transport system, wherein the drying region is configured to generate an airflow to blow one or more surfaces of the one or more containers dry.

21. A non-transitory machine readable storage medium comprising instructions that, when executed by a processing device, cause the processing device to perform operations comprising:
cause one or more containers to be transported, via a transporting device, through a liquid curtain of a rinsing region of a transport system, wherein the transport device is configured to transport the one or more containers through the transport system in a transport direction; and
cause the one or more containers to be transported, via the transporting device, through a drying region of the transport system, wherein the drying region is configured to generate an airflow to flow one or more surfaces of the one or more containers dry.
